(19) United States
(12) Patent Application Publication
(10) Pub. No.: US 2024/0344825 A1
(43) Pub. Date: Oct. 17, 2024

(54) SHAFT ALIGNMENT SYSTEM INCLUDING A MEASURING UNIT EMITTING A LASER BEAM

(71) Applicant: AKTIEBOLAGET SKF, GOTEBORG (SE)

(72) Inventor: Sylvain Georges Henri HUMBERT, Saizerais (FR)

(21) Appl. No.: 18/625,312

(22) Filed: Apr. 3, 2024

(30) Foreign Application Priority Data
Apr. 12, 2023 (DE) 102023203325.9

(51) Int. Cl. G01B 11/27

(52) U.S. Cl. CPC G01B 11/272

(57) ABSTRACT

A shaft alignment system includes a first measuring unit and a second measuring unit. At least one of the first and second measuring units includes a laser adapted to emit a laser beam and the other of the first and second measuring units is adapted to detect the emitted laser beam. The laser is adapted to emit a laser beam on at least two different brightness levels and the laser beam has a green color.

### CROSS-REFERENCE

This application claims priority to German patent application no. 102023203325.9 filed on Apr. 12, 2023, the contents of which are fully incorporated herein by reference.

### BACKGROUND OF THE INVENTION

The present invention relates to a shaft alignment systems, and more particularly to such systems that include a measuring unit emitting a laser beam and a method for using lasers for the set-up shaft alignment measuring units.

In a power transmission between two rotary shafts, for example via coupling, the driving shaft may be part of a first item of equipment, such as a motor, and the driven shaft may be part of a second item of equipment, such as for example, a pump, a fan, a gear box, etc. A major aspect of keeping machinery running smoothly involves regular maintenance, upkeep and ensuring that the machinery is adequately lubricated and properly aligned. Correct shaft alignment ensures the smooth, efficient transmission of power from the motor to the driven equipment.

In contrast, when the driving shaft and the driven shaft of the rotating machinery are misaligned, the risk of costly, unplanned machine downtime increases significantly. The failure to align the shafts properly increases the amount of stress on the units, resulting in a variety of potential problems that may ultimately seriously impact a company's “bottom line”. It has been determined that shaft misalignment is responsible for as much as 50% of all costs related to machinery breakdowns.

Shaft misalignment increases friction, resulting in excessive wear, excessive energy consumption, and the possibility of premature breakdown of motor and/or equipment. These misalignments also cause excessive wear on bearings and seals, leading to premature failure. Further, shaft misalignment often leads to premature shaft and coupling failure, excessive seal lubricant leakage, failure of coupling and foundation bolts, and increased vibration and noise.

Specifically, shaft misalignment occurs when the axis of the motor shaft and the axis of the driven equipment shaft are not in line or aligned with each other. The misalignment may be due to parallel or angular misalignment or a combination of both. With parallel misalignment, the axes of the two shafts are parallel, but offset, from each other. With angular misalignment, the axes of the shafts extend at an angle with respect to each other.

Accordingly, proper shaft alignment is one of the most important factors influencing rotating equipment performance. Shaft alignment eliminates certain risks of breakdowns, reduces unplanned downtime that results in loss of production, and minimizes maintenance costs.

Machines need to be aligned in both the horizontal and vertical planes. When performing a shaft alignment, an operator first needs to pre-align the shafts approximately, then finely adjust the alignment. Pre-alignment is a standard operation traditionally done with a roll meter. This operation includes measuring a distance between the driven shaft and the driving shaft, measuring a distance between the driven shaft and the first motor foot, and measuring a distance between the two motor feet.

Then, fine adjustment of the alignment can be made by means of different methods. Three such methods include visual inspection combined with a straightedge or ruler, the use of dial indicators, or the use of laser guided tools.

The traditional method including a visual inspection combined with a straightedge or ruler is still in common use. The straightedge is positioned on two bearings supporting one or more shafts while a maintenance inspector visually assesses whether or not the components are properly aligned. Such a rough method has the advantage of being quick and relatively easy, but it is also highly inaccurate and does not provide the exacting degree of accuracy required.

Dial indicators represent another traditional method of measuring shaft misalignment. Although dial indicators do offer a higher degree of accuracy, they also present certain problems. Not only do they require a high level of technical skill to be used properly, but the effort is also generally quite time-consuming. Furthermore, dial indicators do not provide real-time values that enable technicians to simultaneously measure and obtain correct alignment. Instead, the dial indicators must be removed and then reinstalled after each alignment adjustment is completed. As a result, the process for obtaining critical measurements, such as feet values and coupling values, can be lengthy or time consuming. Feet values indicate whether the pedestal or footing on which the machine(s) rests is loose or compromised in some other way. Coupling values attest to the integrity of a coupling connecting two shafts.

The method using laser-guided tools is quick, accurate, easy to use, and requires only a single installation. In addition, laser-guided tools deliver consistently better accuracy than dial indicators and do not require special skills to obtain accurate results virtually every time. Shaft alignment laser guided tools typically consist of two units, each capable of emitting a precise laser beam and detecting a laser beam from the other unit, plus a handheld control device.

Laser alignment methods provide a marked improvement compared to traditional methods. A laser-driven shaft alignment device enables alignment adjustment with far more speed and accuracy than either the straightedge or dial method.

The foregoing teaches that the fastest and most accurate known way to align shafts is using a laser alignment method after pre-alignment has been done. Nevertheless, this alignment method is still somewhat time consuming. Effectively, pre-alignment is still performed with a roll meter or similar device, and only after such pre-alignment is the laser-alignment method used. The substantial precision of a laser suggests this sequence of steps.

In other words, shaft alignment according to prior art is not that quick. Further, it requires some good technical skills.

### SUMMARY OF THE INVENTION

In view of the foregoing, one object of the present invention is to reduce time needed for the complete shaft alignment. Another object of the present invention is to make shaft alignment easier.

The above mentioned objects are achieved by one preferred embodiment of the invention, with a shaft alignment system comprising a first measuring unit and a second measuring unit, at least one of the first and second measuring units comprising a laser adapted to emit a laser beam, the other one of the first and second measuring units being adapted to detect the emitted laser beam. In the present shaft-alignment system, the laser is adapted to emit on at least two different brightness levels and the laser emits in green color.

Because higher brightness level in green color is very visible, pre-alignment of the shafts with the measuring units is made easy. Movements of the shafts relative to each other are visualized by the laser beam. This is quick and simple compared with pre-alignment according to prior art. The complicated and time-consuming pre-alignment processes of the prior art have been, due to the present invention, changed to a simple and quick process. And because lower brightness levels in green color are very precise, without inconvenience for the user, it is easy to fine align the shafts with the measuring units. The last can measure small offsets for final adjustment. In other words, the same system allows both pre-alignment and fine alignment of the shafts. As such, the shaft alignment system according to the present invention reduces the time needed for the complete shaft alignment and makes shaft alignment easier.

In a non-limiting way, in the shaft alignment system, one of the two brightness levels is high and the other one of the two brightness levels is low. Initial set up is performed with the bright green laser at full power and the final alignment process is done with the same laser at a dimmed level. The first stage of the alignment, done with the bright green laser, makes the displacements of the shafts very visible, and facilitates quick adjustment operations.

In one embodiment, the brightness of the laser beams may be adjusted or varied in a step by step manner or incrementally. This provides the capability of adjusting the intensity of the laser beam to a specific level that is comfortable for a particular operator. Because such adjustment is possible step by step, it is easy to pre-set the intensity.

In another embodiment, the brightness of the laser beams may be varied continuously, i.e., is continuously adjustable. Such a continuous adjustment is particularly useful when there are light reflections that disturb vision.

Further, the one of the first and second measuring units sends and receives the laser beam, the other one of the first and second measuring units sending back the laser beam. Because only one measuring unit includes a laser, costs are saved.

Preferably, the power of each laser beam is between one half milliwatt (0.5 mW) and ten milliwatts (10 mW). Such power levels provide good visibility for the pre-alignment stage and optimizes accuracy for the fine-adjustment stage. Also, such power levels of the laser beams are not so high as to potentially harm an operator.

Further, the wavelength of each laser beam is preferably between five hundred nanometers (500 nm) and five hundred fifty nanometers (550 nm). This range of wavelength values provides a very visible green beam.

The present invention also relates to a shaft alignment method, including the steps of securely mounting a first laser measuring unit to a first shaft, securely mounting a second laser measuring unit to a second shaft, at least one of the first and second measuring units being adapted to emit a laser beam and the other one of the first and second measuring units being adapted to detect the emitted laser beam. According to this method, the laser emits in green color. The method further includes the steps of getting a pre-alignment of the shafts with a high brightness level and achieving fine alignment of the shafts with a lower brightness level. The method further comprises a step of high brightness level adjustment, the power of the laser beam starting at one half milliwatt (0.5 mW) and rising to ten milliwatts (10 mW).

Preferably, the method further comprises a step of documenting alignment values by measuring misalignments, by transmitting the alignment correction values to a storage device, by dating the operations carried out. The method comprises a step of varying the brightness step by step or incrementally. Alternatively, the method comprises a step of varying the brightness continuously.

### BRIEF DESCRIPTION OF THE SEVERAL VIEWS OF THE DRAWINGS

In the following, the invention will be described in greater detail with reference to a non-limiting embodiment shown in attached drawing, in which:

FIG. 1 is a perspective view of a shaft alignment system according to one embodiment of the invention.

### DETAILED DESCRIPTION OF THE INVENTION

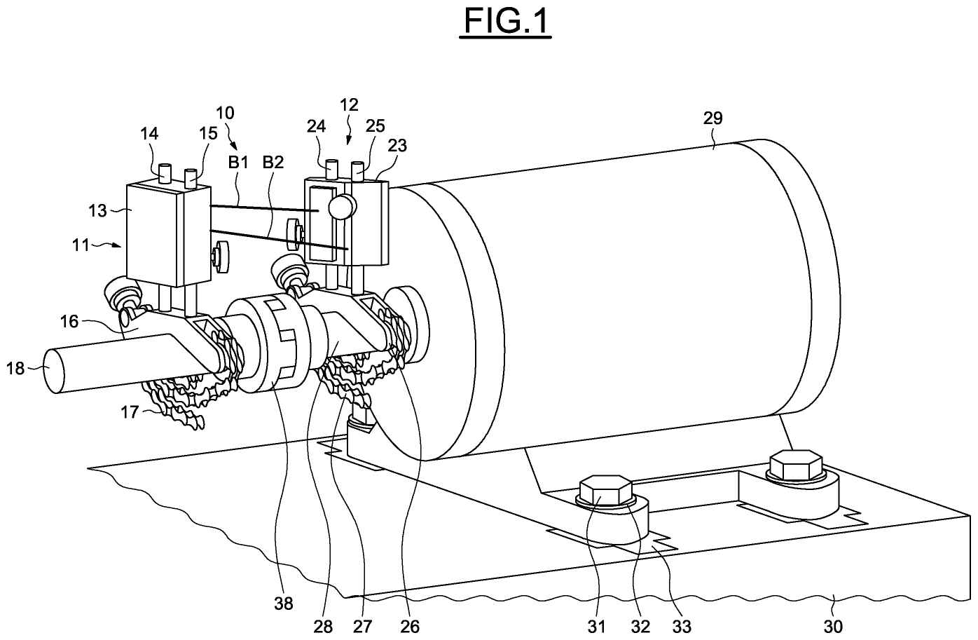

A preferred embodiment of a shaft alignment system 10, according to the invention, is shown in FIG. 1. The system 10 basically comprises a first measuring unit 11 and a second measuring unit 12.

In an exemplary embodiment, the first measuring unit 11 includes a main part 13, two connecting rods 14 and 15, a bracket 16 and a chain 17. In a known way, the bracket 16 and the chain 17 are removably attached to a shaft 18 of an item of equipment, such as for example, a pump, a fan, a gear box, etc. The item of equipment is not shown. The rods 14, 15 are secured to the bracket 16, and the main part 13 is secured to the rods 14, 15 so as to enable precise and stable positioning of the main part 13 in relation to the shaft 18. Alternatively, other appropriate fastening means may be used to secure the main part 13 to the shaft 18.

Similarly, the second measuring unit 12 includes a main part 23, two connecting rods 24 and 25, a bracket 26 and a chain 27. The bracket 26 and the chain 27 are removably attached to a shaft 28 of an electric motor 29, such that the shaft 28 is a “driving shaft” and the shaft 18 is a “driven shaft”. The rods 24, 25 are secured to the bracket 26 and the main part 23 is secured to the rods 24, 25 so as to enable precise and stable positioning of the main part 23 in relation to the shaft 28. However, alternative fastening means may be used to secure the main part 23 to the shaft 28.

The motor 29 is held in a stable position on a frame 30 by means of screws 31 and washers 32. Other attachment means may be used, but screws 31 and washers 32 are economical and relatively easy to implement. Adjustment of the motor 29 position relative to the frame 30 is preferably accomplished by means of wedges 33 or shims 33, which is economical and easy to implement, although other positioning means may alternatively be used. Similarly, while not shown in FIG. 1, the item of equipment that includes the driven shaft 18 is preferably held in a stable position on the frame 30 by means of screws and washers. The position adjustment of the equipment relative to the frame 30 is also preferably made by means of wedges or shims.

The shaft 18 of the “driven” item of equipment and the shaft 28 of the motor 29 are preferably connected to each other by means of a coupling joint 38. The coupling joint 38 is used to transmit power and torque between the two shafts 18, 28.

In a non-limiting way, the first measuring unit 11 includes a laser emitting a laser beam B1 and the second measuring unit 12 is configured to detect the laser beam B1 from the first measuring unit 11. Reciprocally or correspondingly, the second measuring unit 12 includes a laser emitting a laser beam B2 and the first measuring unit 11 is configured to detect the laser beam B2 from the second measuring unit 12. In a non-limiting way, the first measuring unit 11 consists of a laser emitter and a laser sensor or detector and the second measuring unit 12 also consists of a laser emitter and a laser sensor/detector.

Each laser is a device implementing the laser phenomenon to generate a spatially and temporally coherent beam of radiation or laser beam B1 or B2. The laser emitter of each measuring unit 11 or 12 shoots or directs a laser beam B1, B2, respectively, across the shafts 18, 28 to the sensor/detector of the other measuring unit 12, 11 in a single beam laser set-up. In other words, both measuring units 11, 12 emit a laser beam and both units 11, 12 simultaneously act as a sensor or detector. Such an arrangement is known as a “dual beam” laser. As the laser beams B1, B2 are being emitted, one shaft 18 or 28 is rotated to find the center lines of rotation (i.e., rotational axes) between the two shafts 18, 28.

Further, the measuring units 11, 12 may be either offset from each other, have an angular misalignment or both. The laser sensors send information to a display unit or tablet that displays the alignment. This information may be sent to a calculator or a computer, and the software will consider allowable tolerances issued by manufacturers to determine if realignment is necessary. The laser shaft alignment system 10 performs calculations and displays them, for example graphically, to help with the alignment process. Once the misalignment has been identified, one movable piece of equipment is adjusted vertically and/or horizontally. The goal is to come as close to coaxial, or perfectly aligned, as possible.

The laser of the first measuring unit 11 is configured to emit the laser beam B1 on at least two different brightness levels and is configured to emit a beam B1 having a green color. Similarly, the laser of the second measuring unit 12 is configured to emit the laser beam B2 on at least two different brightness levels and is configured to emit a beam B2 having a green color. A green colored laser beam is very noticeable even in broad daylight, or in the presence of light reflections, such that implementation of the shaft alignment system 10 is relatively easy and pleasant. Specifically, an operator may first use the high brightness level of the beams B1, B2 for pre-alignment of the shafts 18, 28 and only needs to check the point or line of impact of each laser beam B1, B2, without using tools or a measuring means. Then, the operator may use the low brightness level of the beams B1, B2 for fine alignment of the shafts 18, 28, based upon the values measured by the system 10.

A transition from the high brightness level to the low brightness level, or vice versa, may be performed in different ways. One possibility is to vary the brightness level step by step or incrementally. Thereby, the operator may adjust the intensity of the laser beam at a comfortable level since visual sensitivity varies from person to person, and incremental adjustment enables an easier return to normal settings. Another possibility is to vary the brightness level continuously, such that the operator may slightly adjust the brightness level, for example to compensate for the presence of a light reflection.

Preferably, the wavelength of each laser beam B1, B2 is between five hundred nanometers (500 nm) and five hundred fifty nanometers (550 nm). Such a range of wavelengths optimizes the visibility of each beam B1, B2, especially for a high level of power. Nevertheless, the power of each beam B1, B2 is not too high, preferably between one-half milliwatt (0.5 mW) and ten milliwatts (10 mW). In particular, a power level of about one milliwatt (1 mW) has been found to provide good results. In any case, it is necessary to maintain such power levels of the beams B1, B2 so as to ensure the safety of the operator.

In addition, the shaft alignment system 10 preferably documents or records the values, which can be downloaded to a computer and used as a benchmark for future alignment inspections. The system 10 may be provided with a built-in step-by-step alignment process, from preparation, inspection, and evaluation through correction, reporting and analysis. The shaft alignment system 10 may also include a database to store data regarding visual inspections of oil leakage, oil level, foundation bolt status, wear indications or other desired information.

While a preferred embodiment of the present invention has been illustrated and described herein, it should be understood that variations and modifications of the present invention within the scope of the attached claims may exist. For example, the shaft alignment system 10 may use a laser emitter that shoots or directs a laser across the shafts 18, 28 to a sensor in a single beam laser set-up.

The present invention may advantageously be used in all applications where two shafts must be aligned plane-parallel or essentially plane-parallel.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A shaft alignment system comprising:
a first measuring unit; and
a second measuring unit;
wherein at least one of the first and second measuring units includes a laser adapted to emit a laser beam of at least two different brightness levels, the laser beam having a green color; and
wherein the other of the first and second measuring units is adapted to detect the emitted laser beam.

2. The shaft alignment system according to claim 1, wherein one of the two brightness levels is high and the other one of the two brightness levels is low.

3. The shaft alignment system according to claim 1, wherein the at least one of the first and second measuring units is configured to emit and receive the laser beam and the other one of the first and second measuring units is configured to send back the laser beam to the at least one of the first and second measuring units.

4. The shaft alignment system according to claim 1, wherein the power of the laser beam emitted by the laser of the at least one of the first and second measuring units is between one half of a milliwatt (0.5 mW) and ten milliwatts (10 mW).

5. The shaft alignment system according to claim 1, wherein the wavelength of the laser beam is between five hundred nanometers (500 nm) and five hundred fifty nanometers (550 nm).

6. A method of aligning a shaft, the method comprising the steps of:
securely mounting a first laser measuring unit to a first shaft and securely mounting a second laser measuring unit to a second shaft, at least one of the first and second measuring units being adapted to emit a laser beam having a green color and the other one of the first and second measuring units is adapted to detect the emitted laser beam;
pre-aligning the first and second shafts using a high brightness level of the laser beam; and
achieving fine alignment of the shafts using a low brightness level of the laser beam.

7. The method according to claim 6, further comprising a step of adjusting a high brightness level of the laser beam such that the power of the laser beam is between one-half of a milliwatt (0.5 mW) and ten milliwatt (10 mW).

8. The method according to claim 6, further comprising a step of documenting alignment values by measuring misalignments, transmitting the alignment correction values to a storage device, and dating the operations carried out.

9. The method according to claim 6, further comprising a step of incrementally varying the brightness of the laser beam.

10. The method according to claim 6, further comprising a step of continuously varying the brightness of the laser beam.

11. A shaft alignment system for aligning first and second shafts, the system comprising:
a first measuring unit mountable to the first shaft; and
a second measuring unit mountable to the second shaft;
wherein at least one of the first and second measuring units includes a laser adapted to emit a laser beam of at least two different brightness levels, the laser beam having a green color; and
wherein the other of the first and second measuring units is adapted to detect the emitted laser beam.

12. The shaft alignment system according to claim 11, wherein one of the two brightness levels is high and the other one of the two brightness levels is low.

13. The shaft alignment system according to claim 11, wherein the at least one of the first and second measuring units is configured to emit and receive the laser beam and the other one of the first and second measuring units is configured to send back the laser beam to the at least one of the first and second measuring units.

14. The shaft alignment system according to claim 11, wherein the power of the laser beam emitted by the laser of the at least one of the first and second measuring units is between one half of a milliwatt (0.5 mW) and ten milliwatts (10 mW).

15. The shaft alignment system according to claim 11, wherein the wavelength of the laser beam is between five hundred nanometers (500 nm) and five hundred fifty nanometers (550 nm).

16. The shaft alignment system according to claim 11, wherein each one of the first and second measuring units includes a bracket mountable to one of the first and second shafts, a main part including a laser emitter and a laser detector, and at least one connecting rod connecting the main part to the bracket.

17. The shaft alignment system according to claim 16, wherein the bracket of each one of the first and second measuring units is removably attached to the one of the first and second shafts.
